(19) United States
(12) Patent Application Publication
(10) Pub. No.: US 2011/0293861 A1
(43) Pub. Date: Dec. 1, 2011

(54) Plastic Hollow Plate

(76) Inventor: Hua Sheng Chen, Xinying (TW)

(21) Appl. No.: 13/008,986

(22) Filed: Jan. 19, 2011

(30) Foreign Application Priority Data
May 31, 2010 (TW) 099210225

(51) Int. Cl. B32B 3/22; E06B 3/663; E06B 3/66

(52) U.S. Cl. 428/34; 428/188

(57) ABSTRACT

A plastic hollow plate is composed of an upper plate, a lower plate, and plural ribs connected between the upper plate and the lower plate. The ribs are positioned obliquely in parallel so as to shield sunlight. And with plural inclined passages formed between every two adjacent ribs, the plastic hollow plate can allow part sunlight to pass through.

### BACKGROUND OF THE INVENTION

1. Field of the Invention

This invention relates to a plastic hollow plate, particularly to one able to simultaneously shield and allow part sunlight pass through.

2. Description of the Prior Art

As shown in FIG. 1, a conventional plastic hollow plate is composed of an upper plate 10, a lower plate 11 and a plurality of ribs 12 vertically connected between the upper plate 10 and the lower plate 11. As the conventional plastic hollow plate is light in weight, it is therefore widely utilized, even for shielding sunlight. Commonly, in order to have a good transparency, the upper plate 10, the lower plate 11 and the ribs 12 are made of transparent polycarbonate, integrally formed. However, when it is employed as a roof of a garage, it becomes very hot under the roof owing to sunlight passing through. And this flaw has long been bothering users.

### SUMMARY OF THE INVENTION

The object of this invention is to offer a plastic hollow plate able to simultaneously shield and allow part sunlight to pass through.

The main characteristics of the invention are an upper plate, a lower plate, and a plurality of ribs connected between the upper plate and the lower plate. The ribs are positioned obliquely in parallel so as to shield sunlight. And with plural inclined passages formed between every two adjacent ribs, part sunlight can pass through to provide brightness.

### BRIEF DESCRIPTION OF DRAWINGS

This invention is better understood by referring to the accompanying drawings, wherein:

FIG. 1 is a cross-sectional view of a conventional plastic hollow plate;

FIG. 2 is a cross-sectional view of a first preferred embodiment of a plastic hollow plate in the present invention;

FIG. 3 is a cross-sectional view of a second preferred embodiment of a plastic hollow plate in the present invention;

FIG. 4 is a cross-sectional view of a third preferred embodiment of a plastic hollow plate in the present invention;

FIG. 5 is a cross-sectional view of a fourth preferred embodiment of a plastic hollow plate in the present invention; and

FIG. 6 is a cross-sectional view of a fifth preferred embodiment of a plastic hollow plate in the present invention.

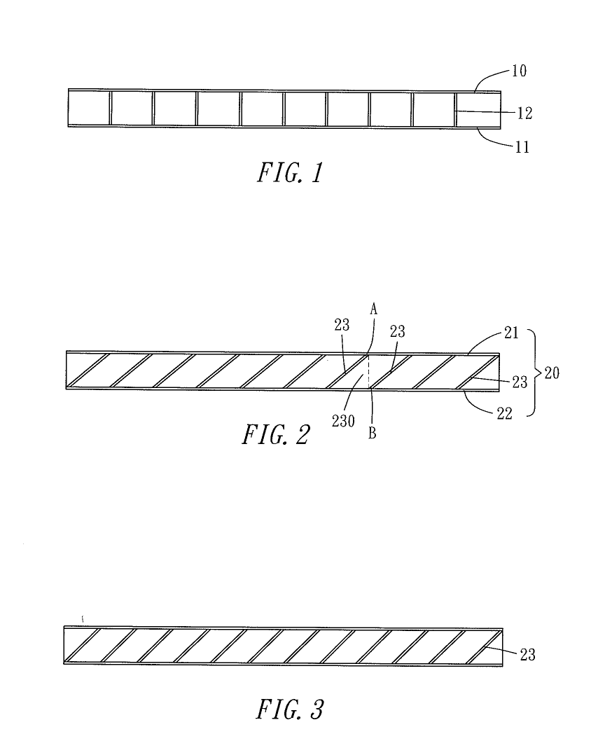

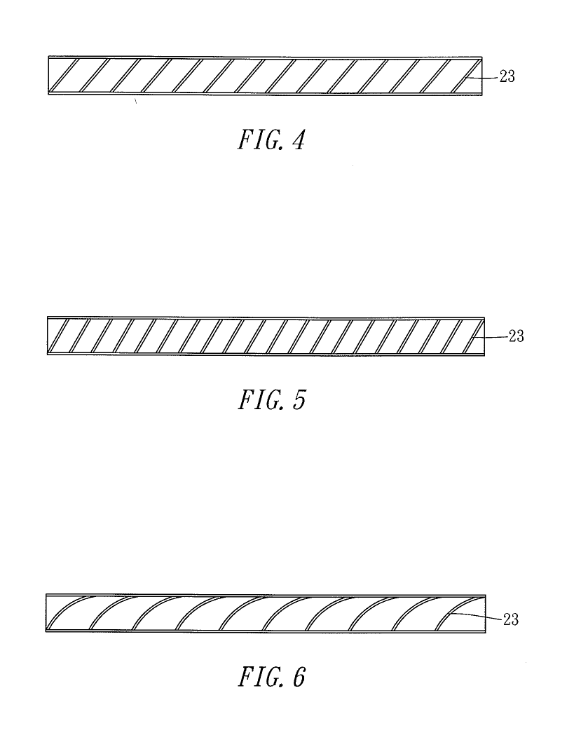

### DETAILED DESCRIPTION OF THE PREFERRED EMBODIMENT

As shown in FIG. 2, a first preferred embodiment of a plastic hollow plate 20 in the present invention includes an upper plate 21, a lower plate 22 and a plurality of ribs 23.

The upper plate 21 is made of transparent plastics.

The lower plate 22 is also made of transparent plastics.

The ribs 23 are connected between the upper plate 21 and the lower plate 22, made of light-shielding plastics that can be colored ABS or PET etc. The ribs 23 are positioned obliquely in parallel, with an inclined passage 230 formed between every two adjacent ribs 23. Each of the ribs 23 is connected with the upper plate 21 at a connecting point “A” and with the lower plate 22 at a connecting point “B”. For every two adjacent ribs 23, the connecting point “A” of the rear rib 23 and the connecting point “B” of the front rib 23 are located on a same vertical line.

In using, when the plastic hollow plate 20 is exposed to sunlight, part of sunlight is to be shielded by the ribs 23 and part of it is to pass through the passages 230 to provide brightness. So the plastic hollow plate 20 can simultaneously shield and allow part sunlight to pass through.

Next, as shown in FIGS. 3˜5, the ribs 23 can be positioned in diverse angles, depending on how strong the plastic hollow plate 20 is needed. The more the ribs 23 are used, the stronger the plastic hollow plate 20 is.

Furthermore, as shown in FIG. 6, the ribs 23 can be shaped straight or curved.

While the preferred embodiment of the invention has been described above, it will be recognized and understood that various modifications may be made therein and the appended claims are intended to cover all such modifications that may fall within the spirit and scope of the invention.

What is claimed is:

1. A plastic hollow plate comprising:
an upper plate;
a lower plate; and
a plurality of ribs made of light-shielding plastics and obliquely connected in parallel between said upper plate and said lower plate so that an inclined passage is formed between every two adjacent ribs.

2. The plastic hollow plate as claimed in claim 1, wherein said upper plate and said lower plate are transparent and said ribs are colored.

3. The plastic hollow sheet as claimed in claim 2, wherein each of said ribs is connected with said 15 upper plate at a point located on a same vertical line on which is positioned also a point of a rib in front of said rib connected with said lower plate.

4. The plastic hollow plate as claimed in claim 3, wherein said ribs are formed straight.

5. The plastic hollow sheet as claimed in claim 3, wherein said ribs are formed curved.

6. The plastic hollow sheet as claimed in claim 1, wherein each of said ribs is connected with said upper plate at a point located on a same vertical line on 25 which is positioned also a point of a rib in front of said rib connected with said lower plate.

7. The plastic hollow plate as claimed in claim 6, wherein said ribs are formed straight.

8. The plastic hollow sheet as claimed in claim 6, wherein said ribs are formed curved.
